(19) United States
(12) Patent Application Publication
(10) Pub. No.: US 2011/0198038 A1
(43) Pub. Date: Aug. 18, 2011

(54) SHEET PEELING APPARATUS AND PEELING METHOD

(75) Inventors: Takahisa Yoshioka, Tokyo (JP); Takeshi Takano, Tokyo (JP)

(73) Assignee: LINTEC CORPORATION, Tokyo (JP)

(21) Appl. No.: 13/124,939

(22) PCT Filed: Oct. 13, 2009
(86) PCT No.: PCT/JP2009/067692

§ 371 Date: Apr. 19, 2011

(30) Foreign Application Priority Data
Oct. 22, 2008 (JP) 2008-271792

(51) Int. Cl. B32B 38/10

(52) U.S. Cl. 156/543

(57) ABSTRACT

A sheet peeling apparatus 10 includes: a holding means 11 for holding a wafer W on which an adhesive sheet S is stuck; a sticking means 16 for sticking a peeling tape PT on the adhesion sheet S; and a peeling means 15 for peeling off the adhesive sheet S from the wafer W through the peeling tape PT. The peeling means 15 has first and second rollers 31, 32 between which the peeling tape PT and the adhesive sheet S may be pinched. The first roller 31 is provided such that a peeled section of the adhesive sheet S and an unpeeled section of the adhesive sheet S are bendable so as to be opposed to each other. The first roller 31 is displaced in a direction toward and away from the wafer W through a displacing means 30, and provided such that the peeling angle α between the peeling tape PT and/or the adhesive sheet S and the wafer W may be adjusted.

### FIELD OF THE INVENTION

The present invention relates to a sheet peeling apparatus and peeling method, and more particularly to a sheet peeling apparatus and peeling method suitable for adhering a peeling tape to an adhesive sheet stuck on an adherend, and peeling off the adhesive sheet through the peeling tape.

### BACKGROUND OF THE ART

In a process for treating semiconductor wafers (hereinafter, simply referred to as “wafers”), wafers are stuck with a protective adhesive sheet on the circuit surface thereof, subjected to various treatments such as rear face grinding, and mounted on a ring frame via a dicing sheet, and thereafter the adhesive sheet is peeled off before dicing. An apparatus for peeling off such adhesive sheet is disclosed, for example, in Patent document 1. In this document, a process for peeling off an adhesive sheet from a wafer is performed by pressing and sticking a peeling tape on the adhesive sheet with a pressing head, and then moving a roller, around which the peeling tape is wound, relative to the wafer.

Patent document 1: Japanese Patent Application Laid-Open No. 2007-36111

### SUMMARY OF THE INVENTION

### Problem to be Solved by the Invention

However, in Patent document 1, the moving direction of the roller is a lateral direction, i.e. parallel to the surface of the wafer. Thus, the peeling angle between the adhesive sheet and the wafer is always constant, so that the peeling angle is not able to be changed in accordance with any conditions such as ultra thinning of wafers, and adhesive properties of the adhesive sheet. Therefore, there arises such a disadvantage that the adhesive sheet is not peeled off from the wafer and they are lifted up together so that the wafer is damaged.

### Object of the Invention

The present invention has been proposed in view of the above disadvantages. It is an object of the present invention to provide a sheet peeling apparatus and peeling method capable of preventing an adherend from being lifted up together with an adhesive sheet when the adhesive sheet is peeled off through a peeling tape.

### Means for Solving Problems

In order to achieve the above object, the present invention adopts such an arrangement that a sheet peeling apparatus comprises: a holding means for holding an adherend on which an adhesive sheet is stuck; a sticking means for sticking a peeling tape on the adhesive sheet; and a peeling means for peeling off the adhesive sheet from the adherend through the peeling tape,
wherein the peeling means includes first and second rollers between which the peeling tape and the adhesive sheet may be pinched, the first roller being provided such that a peeled section of the adhesive sheet and an unpeeled section of the adhesive sheet are bendable so as to be opposed to each other, and the peeling angle between the peeling tape and/or the adhesive sheet and the adherend being adjustably provided.

In the present invention, such an arrangement is preferably adopted that the first roller is provided displaceably in a direction toward and away from the adherend through a displacing means, and provided such that the peeling angle may be adjusted by such displacement.

Further, a peeling method of the present invention adopts a sheet peeling method for sticking a peeling tape on an adhesive sheet stuck on an adherend, and peeling off the adhesive sheet from the adherend through the peeling tape, comprising the steps of: holding the adherend with a holding means;
feeding out the peeling tape, and sticking the peeling tape on the adhesive sheet stuck on the adherend; and
peeling off the adhesive sheet after the adhesive sheet is bended so as to be opposed to an unpeeled section of the adhesive sheet, and the peeling angle between the peeling tape and/or the adhesive sheet and the adherend are adjusted.

### Effect of the Invention

According to the present invention, the peeling angle between the adhesive sheet and the adherend may be easily adjusted by the first roller in accordance with various conditions. This may prevent the adhesive sheet and the adherend from being lifted together when peeled off, and the adhesive sheet maybe assuredly and smoothly peeled off.

### BRIEF DESCRIPTION OF THE DRAWINGS

FIG. 1 is a schematic front view of a sheet peeling apparatus according to an embodiment.

FIG. 2 is a front view for illustrating a state in which a peeling tape is fed out from a state shown in FIG. 1.

FIG. 3 is a front view for illustrating a preparatory state in which the peeling tape is further fed out from a state shown in FIG. 2.

FIG. 4 is a front view for illustrating a state in which the peeling tape is stuck on an adhesive sheet

FIG. 5 is a front view for illustrating a state in which the peeling tape is pinched by first and second rollers.

FIGS. 6(A) and 6(B) are partial front views for illustrating that the adhesive sheet is being peeling off.

### EXPLANATION OF REFERENCE NUMERALS

10: sheet peeling apparatus
11: holding means
15: peeling means
16: sticking means
30: displacing means
31: first roller
32: second roller
PT: peeling tape
S: adhesive sheet
W: semiconductor wafer (adherend)
α: peeling angle

### DESCRIPTION OF THE PREFERRED EMBODIMENTS

Hereinafter, an embodiment of the present invention will be described with reference to the drawings.

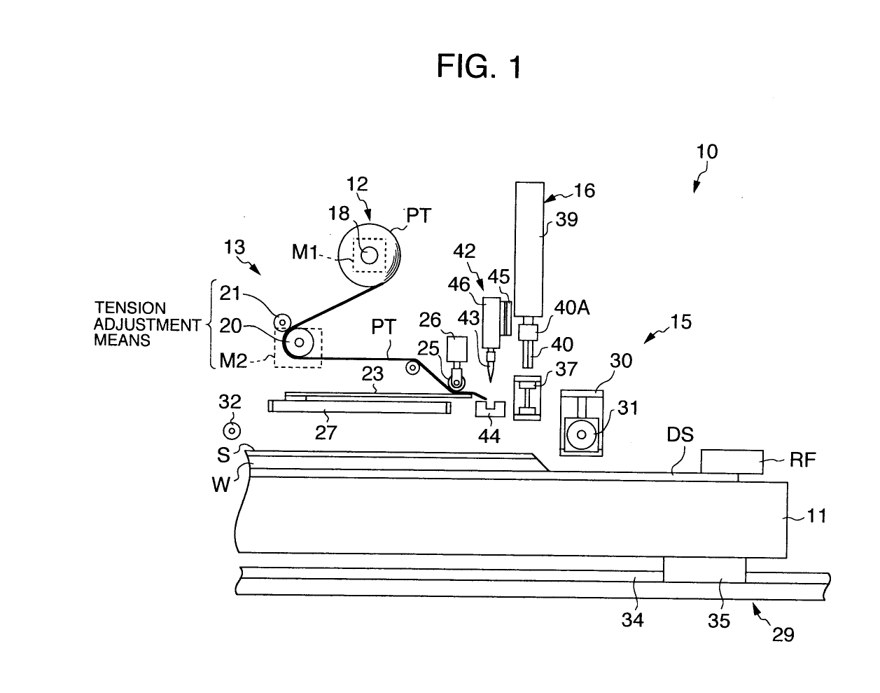

FIG. 1 shows a schematic front view of a sheet peeling apparatus according to an embodiment. In this figure, a sheet peeling apparatus 10 comprises: a holding means 11 for holding a wafer W as an adherend; a supporting means 12 for supporting a strip-shaped peeling tape PT; a feeding out means 13 for feeding out the peeling tape PT; a peeling means 15 for peeling off an adhesive sheet S stuck on a circuit surface (an upper surface in FIG. 1) of the wafer W through the peeling tape PT; and a sticking means 16 for sticking the peeling tape PT on the outer periphery side of the adhesive sheet S. Note that a heat-sensitive adhesive tape is adopted as the peeling tape PT.

The wafer W is held by the holding means 11, in a state in which the wafer W is disposed inside an opening of a ring frame RF and integrated therewith via a dicing sheet DS on the surface (lower surface in FIG. 1) that is opposite to the circuit surface.

The holding means 11 comprises a table for sticking the wafer W integrated with the ring frame RF from the dicing sheet DS side and holding it on an upper surface thereof.

The supporting means 12 comprises a support shaft 18 which is supported by a frame (not shown) and supports the peeling tape PT which is wound therearound, and a motor M1 for rotating the support shaft 18.

The feeding out means 13 comprises a drive roller 20 capable of being rotatably driven through a motor M2, a pinch roller 21 for pinching the peeling tape PT between the drive roller 20 and the pinch roller 21, a plate-shaped guide member 23 which is oriented in a substantially lateral direction, a freely rotatable press roller 25 for pressing the peeling tape PT on the guide member 23, an elevating/lowering cylinder 26 for elevating and lowering the press roller 25. The motor M2 includes a reversibly rotatable torque sensing servomotor or the like, is controlled such that the output of the drive roller 20 is a predetermined torque value, and is configured to be able to rotate in a direction in which the peeling tape PT is fed out to the sticking means 16 side and in a direction opposite to the aforementioned direction, i.e. a direction in which the peeling tape PT is reeled. Here, the motor M2, the drive roller 20, and the pinch roller 21 constitute a tension adjustment means.

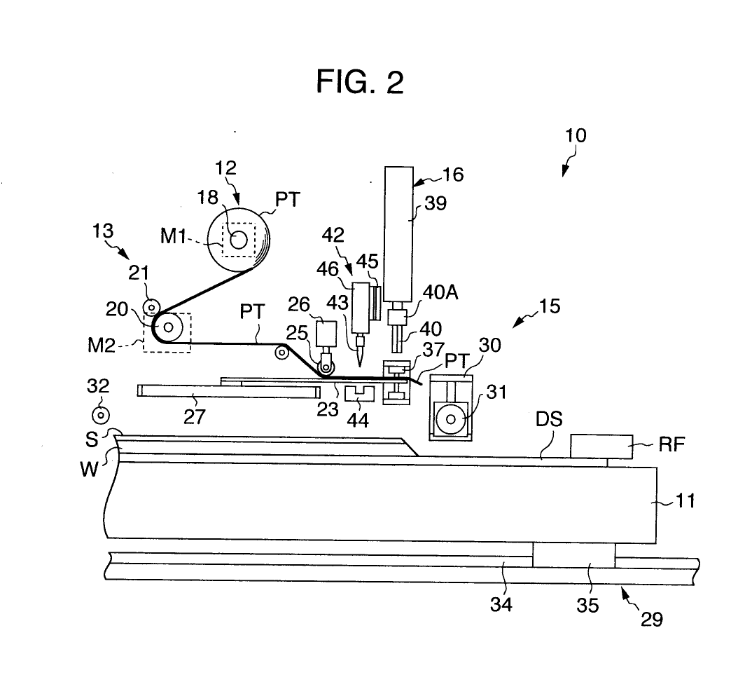

The guide member 23 is provided movably in a left and right direction in FIG. 1 through a cylinder 27. Therefore, the guide member 23, as shown in FIG. 2, supports, from below, the peeling tape PT which is pressed thereon with the press roller 25, and may guide a lead end region thereof to a position that allows for grasp by a chuck as described later.
the peeling means 15 comprises: a moving means 29 for relatively moving the peeling tape PT, which is stuck on the adhesive sheet S, and the holding means 11; a first roller 31 supported above the holding means 11 via a displacing means 30; and a second roller 32 provided to the left side in FIG. 1 of the first roller 31 and may be moved in a left and right direction in FIG. 1 through a driving unit (not shown). The displacing means 30 includes a linear motor and is provided displaceably in a direction in which the first roller 31 is moved toward or away from the wafer W. i.e. in an upper/lower direction in FIG. 1.

The moving means 29 comprises: a linear motor 34 and a slider 35 thereof for moving the holding means 11 in a left and right direction in FIG. 1; and a chuck 37 provided under the sticking means 16 and capable of grasping the peeling tape PT. Note that the chuck 37 is configured to be movable in a left and right direction in FIG. 1 through a drive unit (not shown).

The sticking means 16 comprises a linear motor 39, and a pressing head 40 having a heater 40A as a heating means which is provided movably forward and backward in the an upper/lower direction by using the linear motor 39. The sticking means 16 presses and heats, with the pressing head 40, the peeling tape PT fed out on the upper surface side of the adhesive sheet S by the chuck 37 to weld the peeling tape PT to the adhesive sheet S.

A tape cutting means 42 is provided to the left side in FIG. 1 of the sticking means 16. The tape cutting means 42 comprises a cutter blade 43, a tape-receiving plate 44 provided under the cutting blade 43 and having a recess portion on the upper surface thereof, a cutting cylinder for moving the cutting blade 43 in a direction perpendicular to the paper surface in FIG. 1, a vertical cylinder 46 for moving the cutting blade 43 in the upper/lower direction in FIG. 1.

Next, a method for peeling off an adhesive sheet S by using the sheet peeling apparatus 10 is described.

First, a peeling tape PT is pulled out from the support shaft 18, passes between the drive roller 20 and the pinch roller 21, and thereafter is pressed on the guide member 23 with the press roller 25 while kept in a state in which a lead end side of the peeling tape PT is protruded from an end of the guide member 23.

And, a wafer W integrated with the ring frame RF is held on the upper surface of the holding means 11 through a transporting means (not shown). Then, the right-side outer edge in FIG. 1 of the adhesive sheet S is detected through a sensor (not shown) while the holding means 11 is moved through the linear motor 34 and the slider 35, and the linear motor 34 is controlled so that the outer edge is stopped directly under the pressing head 40.

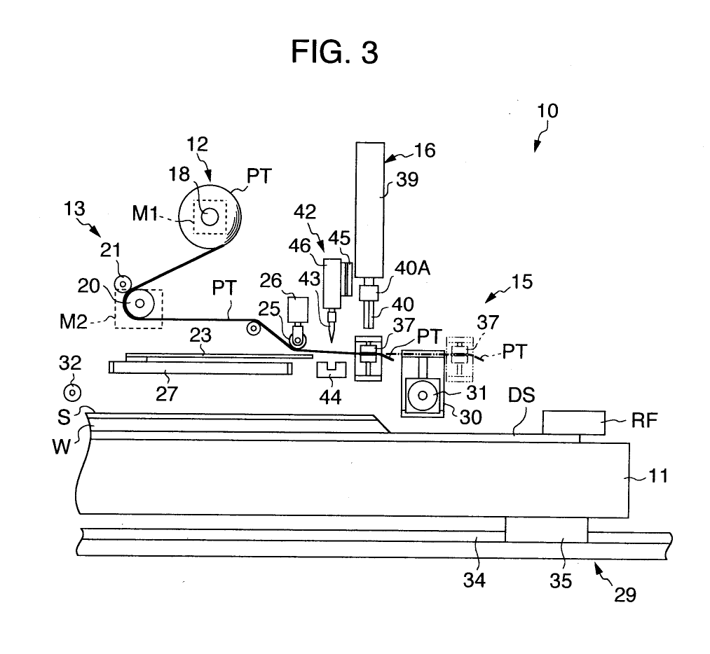

Then, as shown in FIG. 2, the guide member 23 is travelled rightward in FIG. 2 by means of the cylinder 27, while the peeling tape PT is fed out a predetermined length by operating the motor M2 to rotate the drive roller 20. Thus, the guide member 23 and the lead end side of the peeling tape PT are positioned through the chuck 37. Then, when the press roller 25 is evacuated upwardly and the guide member 23 is retreated, the peeling tape PT is left through the chuck 37 and held by the chuck 37 (see FIG. 3). After that, the chuck 37 is moved to a position shown in the dashed-two dotted lines in FIG. 3 so that the peeling tape PT is pulled out, and positioned so as to be opposed to the adhesive sheet S under the pressing head 40. At this time, a lead end side region of the peeling tape PT is positioned so as to overlap above the dicing sheet DS.

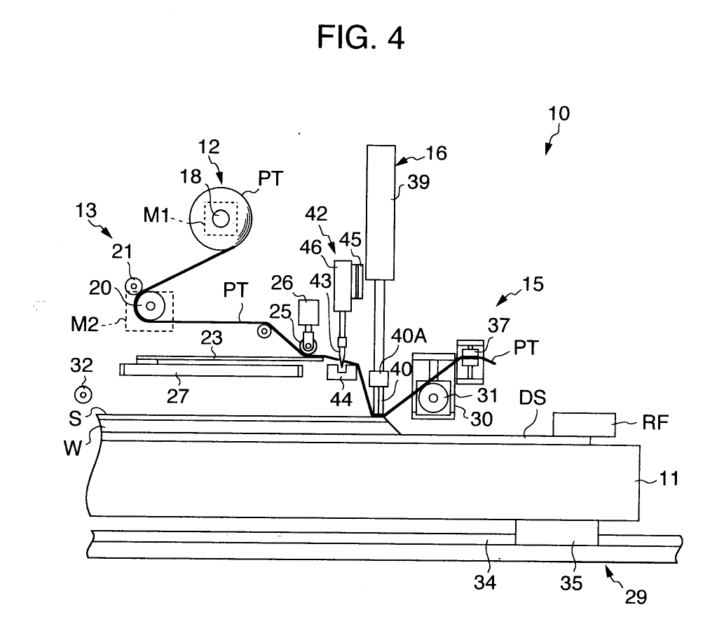

Next, as shown in FIG. 4, the pressing head 40 heated by the heater 40A is moved downward by the linear motor 39, and the peeling tape PT is heated and welded to the adhesive sheet S. Then, the peeling tape PT is pressed with the press roller 25 onto the guide member 23, and the peeling tape PT is cut with the cutting blade 43, on tape-receiving plate 44, by actuating the cylinders 45 and 46.

Note that, from the time the peeling tape PT is grasped by the chuck 37 to the time it is cut, a tension of the peeling tape PT fed out between the chuck 37 and the drive roller 20 is maintained at a predetermined value due to the rotation of the drive roller 20 with the motor M2. Thus, in the states shown in FIGS. 3 and 4, the tension is controlled through the motor M2 such that no slack is produced in the peeling tape PT and the grasp of the peeling tape PT by the chuck 37 is not released.

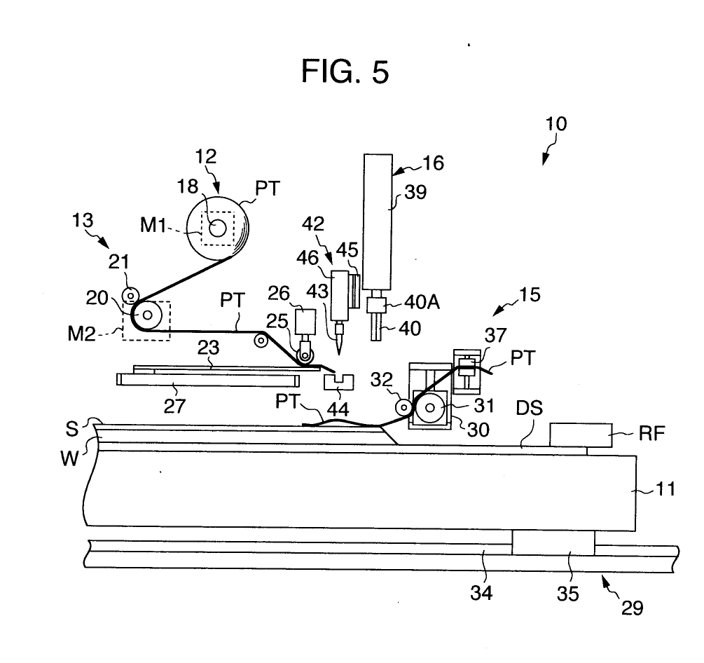

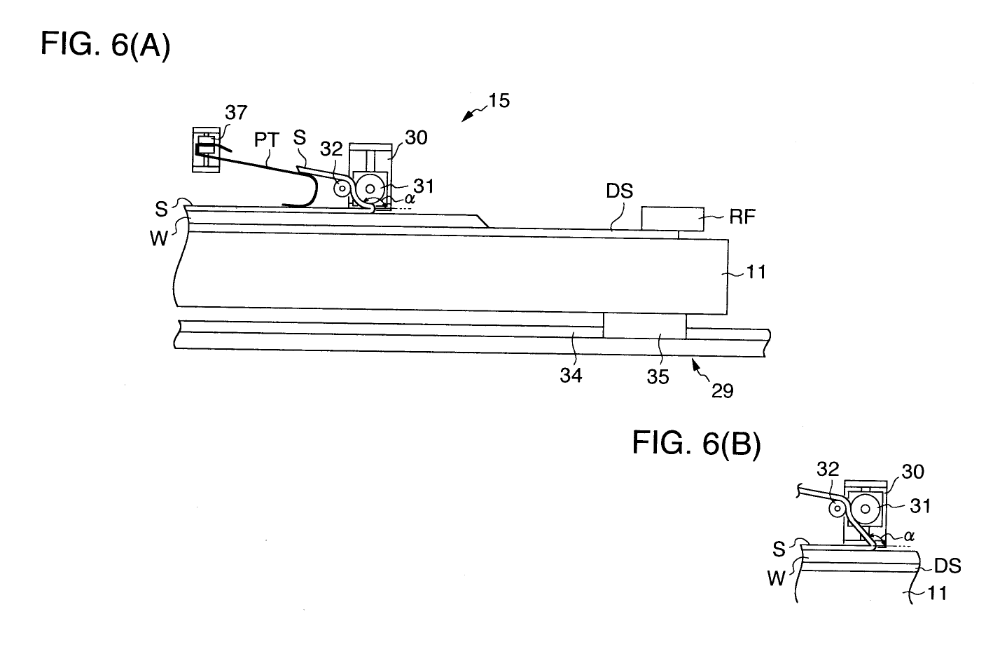

After that, as shown in FIG. 5, the second roller 32 is moved rightward in FIG. 5 to pinch the peeling tape PT between the first and second rollers 31 and 32. Next, the first roller 31 is displaced in an upper/lower direction through the displacing means 30 so that the distance between the first roller 31 and the wafer W is adjusted. Then, the chuck 37 and the holding means 11 are moved through the linear motor 34 and so on such that the peeling tape PT stuck on the adhesive sheet S and the holding means 11 are relatively moved in opposite directions. Thus, the peeling tape PT is bended so as to be opposed to the adhesive sheet S on the wafer W. By further performing the relative movement, as shown in FIGS. 6(A) and 6(B) , a peeled section of the adhesive sheet S and an unpeeled section of the adhesive sheet S are bended at the peeling angle α so as to be opposed, and peeled off.

Note that when the first roller 31 is displaced by the displacing means 30, the peeling angle α increases as the first roller 31 gets closer to the adhesive sheet S stuck on the wafer W. In FIG. 6(A), the displacement amount of the first roller 31 is set such that the nearest part of the first roller 31 relative to the wafer W (a lower part in the figure) is located adjacent to a bended position, and the peeled section of the adhesive sheet S is pressed toward the wafer W side with the first roller 31. Thus, the unpeeled section of the adhesive sheet S just before peeled off and the peeled section of the adhesive sheet S just after peeled off are opposed while being slightly spaced-apart, and the adhesive sheet S is peeled off in a state of being bended at the peeling angle α of about 180°. Also, as shown in FIG. 6(B), when the distance from the wafer W to the first roller 31 is larger than that in FIG. 6(A), the peeling angle α may be set small.

When peeling off the adhesive sheet S is completed, the wafer W is transported to the next process by the transporting means (not shown); the adhesive sheet S and the peeling tape PT stuck thereon are collected by a collecting means (not shown); and thereafter, an operation similar to the above is repeated after the holding means 11, the first rollers 31 and 32, and the chuck 37 return to an initial position.

Therefore, according to the embodiment, peeling may be performed while the peeling angle α is set to about 180° and a bended edge of the adhesive sheet S presses the wafer W downward with the first roller 31, and therefore the wafer W may be prevented from being wound up to the first roller 31 side with the wafer W being unpeeled from the adhesive sheet S. Therefore, the wafer W may effectively be prevented from being damaged when the adhesive sheet S is peeled off. Moreover, since the peeling angle α may be adjusted in accordance with the displacement amount of the first roller 31 provided by the displacing means 30, the magnitude of the peeling angle α may be adjusted in accordance with various conditions.

As described above, the best arrangement, method and the like for carrying out the present invention have been disclosed so far. However, the present invention is not limited to the above.

That is, the present invention has been particularly illustrated and described mainly about a specific embodiment. However, it is possible for those skilled in the art to add various modifications, if necessary, to the above-described embodiment with respect to shape, location, layout and the like without departing from the technical spirit and the range of the object of the present invention.

Therefore, the description limiting the shapes and the like disclosed above is described as an example in order to facilitate understanding of the invention, and is not intended to limit the invention. Therefore, the descriptions of parts name without part or all of the limiting of the shapes and the like thereof are within the invention.

For example, the displacing means 30 and the linear motors 34, 39 may be replaced by a driving means such as an air cylinder and a hydraulic cylinder.

Also, the adherends in the present invention are not limited to semiconductor wafers W, but may include glass plates, steel plates, ceramics, resin plates or the like, and other adherends; and the semiconductor wafers may be silicon wafers or compound wafers.

Further, pressure-sensitive adhesive tapes, other than heat-sensitive adhesive tapes, may be adopted as the peeling tape PT.

Moreover, the peeling angle α is not limited to 180°, but may be changed as appropriate.

Also, for peeling-off operation of the adhesive sheet S, only the holding means 11 may be moved while operation of the chuck 37 is stopped, and on the contrary, only the chuck 37 may be moved while operation of the holding means 11 through the linear motor 34 is stopped.

What is claimed is:

1. A sheet peeling apparatus comprising: a holding means for holding an adherend on which an adhesive sheet is stuck; a sticking means for sticking a peeling tape on the adhesion sheet; and a peeling means for peeling off the adhesive sheet from the adherend through the peeling tape,
wherein the peeling means includes first and second rollers between which the peeling tape and the adhesive sheet may be pinched, the first roller being provided such that a peeled section of the adhesive sheet and an unpeeled section of the adhesive sheet are bendable so as to be opposed to each other, and the peeling angle between the peeling tape and/or the adhesive sheet and the adherend being adjustably provided.

2. The sheet peeling apparatus according to claim 1 wherein the first roller is provided displaceably in a direction toward and away from the adherend through a displacing means, and provided such that the peeling angle may be adjusted by such displacement.

3. A sheet peeling method for sticking a peeling tape on an adhesive sheet stuck on an adherend, and peeling off the adhesive sheet from the adherend through the peeling tape, comprising the steps of:
holding the adherend with a holding means;
feeding out the peeling tape, and sticking the peeling tape on the adhesive sheet stuck on the adherend; and
peeling off the adhesive sheet after the adhesive sheet is bended so as to be opposed to an unpeeled section of the adhesive sheet, and the peeling angle between the peeling tape and/or the adhesive sheet and the adherend are adjusted.
